(19) United States
(12) Patent Application Publication
(10) Pub. No.: US 2024/0342716 A1
(43) Pub. Date: Oct. 17, 2024

(54) LIQUID HANDLING DEVICE FOR ALLOWING THE PRESENCE OR ABSENCE OF A VOLUME OF LIQUID TO BE DETERMINED

(71) Applicant: OSLER DIAGNOSTICS LIMITED, Oxford (GB)

(72) Inventors: Barry LILLIS, Oxford (GB); Jasper MALINSON, Oxford (GB); Jimishkumar PATEL, Oxford (GB); Myles WHITING, Oxford (GB); Richard LUXTON, Oxford (GB); Mark YEOMAN, Oxford (GB)

(21) Appl. No.: 18/293,300

(22) PCT Filed: Jul. 29, 2022
(86) PCT No.: PCT/EP2022/071429

§ 371 Date: Jan. 29, 2024

Related U.S. Application Data
(60) Provisional application No. 63/227,162, filed on Jul. 29, 2021.

(51) Int. Cl. B01L 3/00

(52) U.S. Cl. CPC B01L 3/502746; B01L 3/502715; B01L 3/502738; B01L 2200/0621

(57) ABSTRACT

Embodiments described herein relate to a liquid handling device, comprising: an inlet conduit configured to receive a liquid sample; a first flow path comprising a sample adequacy control chamber in fluidic communication with the inlet conduit, wherein the sample adequacy control chamber is configured to allow the presence or absence of a volume of liquid within the sample adequacy control chamber to be determined; and a second flow path in fluidic communication with the inlet conduit, wherein the second flow path is configured to provide a higher hydraulic resistance than the first flow path.

### FIELD

The present disclosure relates to a liquid handling device for allowing the presence or absence of a volume of liquid to be determined.

### BACKGROUND

Point-of-care diagnostic devices are typically used for carrying out diagnostic tests, such as immunoassays, on a biological sample (such as whole blood, blood serum or blood plasma). In order to carry out such diagnostic tests, the biological sample needs to be transferred to the diagnostic device. The diagnostic device is subsequently inserted into an analyser device (or instrument), which controls the movement of fluids (e.g. biological samples, reagents, buffer solutions, etc.) within the diagnostic device and conducts measurements of biomarkers, in order to conduct the diagnostic test.

Biological samples such as whole blood or blood plasma are typically received in a point-of-care diagnostic device. Existing devices include viewing windows to allow a user to verify that liquid has been received in the device. However, where the viewing window is viewed by a user, the user may not be aware whether a sufficient volume of liquid has been received. This means that, where the liquid is received in the device by some form of user action, the user does not know when they can cease that action.

In addition, the filling of a viewing window may result in unintentional liquid flow into other fluidic components of the device.

Accordingly, there exists a need for devices for allowing the presence or absence of a volume of liquid to be determined, that provide increased ease of use for a user, and minimise unintentional liquid flow into other fluidic components of the device.

### SUMMARY

This summary introduces concepts that are described in more detail in the detailed description. It should not be used to identify essential features of the claimed subject matter, nor to limit the scope of the claimed subject matter.

According to one aspect of the present disclosure, there is provided a liquid handling device, comprising: an inlet conduit configured to receive a liquid sample; a first flow path comprising a sample adequacy control chamber in fluidic communication with the inlet conduit, wherein the sample adequacy control chamber is configured to allow the presence or absence of a volume of liquid within the sample adequacy control chamber to be determined; and a second flow path in fluidic communication with the inlet conduit, wherein the second flow path is configured to provide a higher hydraulic resistance than the first flow path.

The sample adequacy control chamber allows a user to determine whether a specific volume of liquid has been received in the liquid handling device. For example, the user may be able to determine whether a volume of liquid that is sufficient for allowing a diagnostic test to be performed has been received. The higher hydraulic resistance of the second flow path means that liquid fills the sample adequacy control chamber in the first flow path, in preference to the second flow path. This means that the visual indication can be provided to the user without (or while minimising) fluid flow into other fluidic components of the liquid handling device (e.g. into other chambers of a diagnostic cartridge).

The liquid handling device may comprise an indicator region through which the sample adequacy control chamber is viewable, such that a user can determine the presence or absence of the volume of liquid within the sample adequacy control chamber. This means that a user knows when sufficient liquid has been received in the liquid handling device. If a user action is causing liquid to be received in the inlet conduit, the indication to the user means that a user knows when they can cease such an action. In addition, if liquid is received in the liquid handling device by a user applying a force to a liquid extraction mechanism that extracts liquid from a liquid storage container, then the indication to the user means that a user knows when the liquid storage container can be removed from the liquid extraction mechanism, before proceeding with a diagnostic test.

The indicator region through which the sample adequacy control chamber is viewable may be downstream from a sample adequacy control chamber inlet port in the first flow path. If, for example, liquid is received in the liquid handling device by a user applying a force to a liquid extraction mechanism that extracts liquid from a liquid storage container, then the force is applied from above the liquid handling device (e.g. when a diagnostic cartridge is on its side). By providing an indicator region positioned downstream from a sample adequacy control chamber inlet port, the user can easily see the visual indication from above the device when applying the force to the liquid extraction mechanism. The indicator region may be provided in a wall of the liquid handling device. The indicator region may comprise a viewing window in the wall of the liquid handling device. Providing an indicator region positioned downstream from the sample adequacy control chamber inlet port also ensures that the visual indication to the user is provided after the liquid has started filling the sample adequacy control chamber.

The second flow path may comprise an outlet conduit. The outlet conduit may have a smaller cross-sectional area than the inlet conduit. This increases the hydraulic resistance of the second flow path, to encourage liquid flow through the first flow path and into the sample adequacy control chamber. The outlet conduit may be in fluidic communication with the inlet conduit via the sample adequacy control chamber.

The sample adequacy control chamber may comprise a sample adequacy control chamber inlet port configured to receive liquid from the inlet conduit; and a sample adequacy control chamber outlet port in fluidic connection with the second flow path.

The distance between the sample adequacy control chamber outlet port and the indicator region may be less than the distance between the sample adequacy control chamber inlet port and the indicator region. Positioning the sample adequacy control chamber outlet port at a shorter distance to the indicator region than the sample adequacy control chamber inlet port reduces the head pressure on the sample adequacy control chamber outlet port when the liquid handling device is in use (i.e. when the indicator region is oriented upwards, meaning that the indicator region is higher than the inlet conduit). The reduction in head pressure in this orientation discourages liquid flow through the sample adequacy control chamber outlet port (i.e. into the second flow path).

The first flow path may further comprise a metering chamber configured to store a specific volume of liquid, wherein the metering chamber comprises: a metering chamber inlet port configured to receive liquid from the inlet conduit; and a metering chamber outlet port in fluidic connection with the second flow path. The metering chamber retains the specific volume of liquid, reducing the likelihood of displacement of the specific volume if the liquid handling device is moved or shaken.

The first flow path may comprise a connector conduit providing a fluidic connection between the metering chamber and the sample adequacy control chamber. The cross-sectional area of the connector conduit may be smaller than the cross-sectional area of the metering chamber, to minimise the volume of the metering chamber that is viewable through the sample adequacy control chamber. Minimising the volume of the metering chamber viewable through the sample adequacy control chamber reduces the likelihood of a false positive indication that the sample adequacy control chamber comprises the volume of liquid.

The second flow path may comprise an outlet conduit. The cross-sectional area of the connector conduit may be greater than or equal to the cross-sectional area of the outlet conduit. This increases the hydraulic resistance of the second flow path, thereby encouraging liquid flow through the first flow path and into the sample adequacy control chamber.

The sample adequacy control chamber may be downstream from the metering chamber. Positioning the sample adequacy control chamber downstream from the metering chamber ensures that the metering chamber is filled prior to the sample adequacy control chamber, thereby ensuring that the sufficient volume of liquid has been received in the liquid handling device.

The distance between the metering chamber outlet port and the indicator region may be less than the distance between the metering chamber inlet port and the indicator region. Positioning the metering chamber outlet port at a shorter distance to the indicator region to the metering chamber inlet port reduces the head pressure on the metering chamber outlet port when the liquid handling device is in use (i.e. when the indicator region is oriented upwards, meaning that the indicator region is higher than the inlet conduit). The reduction in head pressure in this orientation discourages liquid flow into the second flow path via the metering chamber outlet port.

The second flow path may comprise an outlet conduit section extending in the direction of the indicator region. The extension of the outlet conduit section in the direction of the indicator region increases the potential pressure head within the outlet conduit when the liquid handling device is in use (i.e. when the indicator region is oriented upwards, meaning that the indicator region is higher than the inlet conduit). This increase in potential pressure head within the outlet conduit reduces the tendency of liquid to flow through the second flow path. The second flow path may further comprise an additional outlet conduit section in fluidic communication with the outlet conduit section, wherein the additional outlet conduit section extends in a direction opposite to the direction of extension of the outlet conduit section.

The first flow path may comprise a vented waste chamber in fluidic communication with the sample adequacy control chamber. Using a vented waste chamber provides an outlet for any excess liquid, without such excess liquid filling the second flow path.

The sample adequacy control chamber may comprise a waste outlet providing a fluidic connection to the waste chamber, wherein the waste outlet is located between an upper end and a lower end of the sample adequacy control chamber, wherein the distance between the upper end of the sample adequacy control chamber and the indicator region is less than the distance between the lower end of the sample adequacy control chamber and the indicator region. By positioning a waste outlet in this way, the sample adequacy control chamber may be used to meter a specific volume of liquid, thereby avoiding the need for a separate metering chamber.

The liquid handling device may further comprise a pad of porous material, wherein the pad is configured to contact liquid within the sample adequacy control chamber. Using a pad of porous material provides an indication that the sample adequacy control chamber contains a volume of liquid once liquid flows through the porous material, but occludes the content of the sample adequacy control chamber prior to filling of the sample adequacy control chamber to the required level. This reduces the likelihood of false positive indications that the sample adequacy control chamber comprises the required volume of liquid.

The liquid handling device may alternatively comprise a pad of absorbent material, wherein the pad is configured to absorb liquid within the sample adequacy control chamber. Using a pad of absorbent material provides a persistent indication that the sample adequacy control chamber contains a volume of liquid, thereby allowing a user to easily determine that the sample adequacy control chamber comprises the volume of liquid.

The liquid handling device may further comprise an occluding material provided in a wall of the liquid handling device through which the sample adequacy control chamber is viewable, wherein the occluding material is configured to occlude at least a portion of the sample adequacy control chamber until the occluding material is in contact with a quantity of liquid. The occluding material reduces the likelihood of a false positive indication that the sample adequacy control chamber comprises the volume of liquid, because the user cannot view the content of the sample adequacy control chamber until the occluding material becomes more optically clear.

The liquid handling device may further comprise: a liquid storage container interface configured to provide a fluidic connection to a volume of liquid within a pierceable liquid storage container, the liquid storage container interface comprising a liquid extraction outlet configured to allow liquid to be extracted from the liquid storage container; wherein the liquid extraction outlet is in fluidic communication with the inlet conduit such that liquid extracted from the liquid storage container is received in the inlet conduit. The liquid handling device may therefore be used to extract liquid from a liquid storage container, and to allow the presence or absence of a volume of liquid extracted from the liquid storage container to be determined.

The liquid handling device may further comprise a liquid extraction mechanism actuatable from a first configuration to a second configuration, wherein the liquid extraction mechanism is configured to provide a pressure difference between a volume of gas in the liquid storage container and the liquid extraction outlet, when the liquid extraction mechanism is actuated from the first configuration to the second configuration. The liquid handling device may therefore be used to extract liquid from a liquid storage container using a force applied by a user, and to provide an indication of the presence or absence of a volume of liquid extracted from the liquid storage container, so that the user can cease application of the force used to extract liquid from the liquid storage container.

The indicator region may allow an external device to determine the presence or absence of the volume of liquid within the sample adequacy control chamber using a sensor (e.g. an optical sensor, or an electrochemical sensor). Accordingly, a liquid handling system may comprise the liquid handling device described in any one of the preceding paragraphs and an external device comprising a sensor configured to determine the presence or absence of the volume of liquid within the sample adequacy control chamber (e.g. though the indicator region). The liquid handling device may, for example, be received in an analyser device, which controls the flow of fluids within the liquid handling device in accordance with a diagnostic protocol, in order to carry out a diagnostic test. In such an example, the presence or absence of the volume of liquid may be detected using an optical sensor located within the analyser device. If the optical sensor detects the absence of a volume of liquid within the sample adequacy control chamber, then the diagnostic test may be stopped immediately. This is advantageous in time-critical diagnostic tests, because a user does not need to wait for the diagnostic test to be run and for an error message to be output, meaning that a user can re-attempt the diagnostic test using a separate liquid handling device.

### BRIEF DESCRIPTION OF FIGURES

Specific embodiments are described below by way of example only and with reference to the accompanying drawings, in which:

FIG. 1 is a schematic diagram of a first liquid extraction device in fluidic communication with a cartridge.

FIG. 2A is a schematic diagram of an attachment between the first liquid extraction device and a cartridge.

FIG. 2B is a schematic diagram of an attachment between a second liquid extraction device and a cartridge.

FIG. 3 is an isometric view of a liquid handling device comprising a sample adequacy control chamber.

FIG. 4 is a front view of first and second moulded parts of the liquid handling device shown in FIG. 3.

FIG. 5 shows the assembly of the liquid handling device shown in FIG. 3.

FIG. 6 is a front view of the liquid handling device of FIG. 3 in an orientation used for determining the presence or absence of a volume of liquid, in which some components are shown partially transparent.

FIG. 7 is an isometric view of an alternative liquid handling device comprising a sample adequacy control chamber.

FIG. 8 is a front view of first and second moulded parts of the liquid handling device shown in FIG. 7.

FIG. 9 shows the assembly of the liquid handling device shown in FIG. 7.

FIG. 10 is a front view of the liquid handling device of FIG. 7 in an orientation used for determining the presence or absence of a volume of liquid, in which some components are shown partially transparent.

FIG. 11 is an isometric view of a further alternative liquid handling device comprising a sample adequacy control chamber.

FIG. 12 is a front view of first and second moulded parts of the liquid handling device shown in FIG. 11.

FIG. 13 shows the assembly of the liquid handling device shown in FIG. 11.

FIG. 14 is a front view of the liquid handling device of FIG. 11 in an orientation used for determining the presence or absence of a volume of liquid, in which some components are shown partially transparent.

FIG. 15 shows a blood collection tube being inserted into a liquid extraction device in a vertical orientation.

FIG. 16A is a schematic diagram of a fluidic configuration of a liquid handling device comprising a sample adequacy control chamber.

FIG. 16B is a schematic diagram of a circuit equivalent to the fluidic configuration shown in FIG. 16A.

### DETAILED DESCRIPTION

Implementations of the present disclosure are explained below with particular reference to a liquid handling device that includes a sample adequacy indicator to indicate whether a volume of sample received in the device is sufficient for carrying out a diagnostic test on the sample. It will be appreciated, however, that the implementations described herein may also be used to indicate the adequacy of liquid samples used in other contexts.

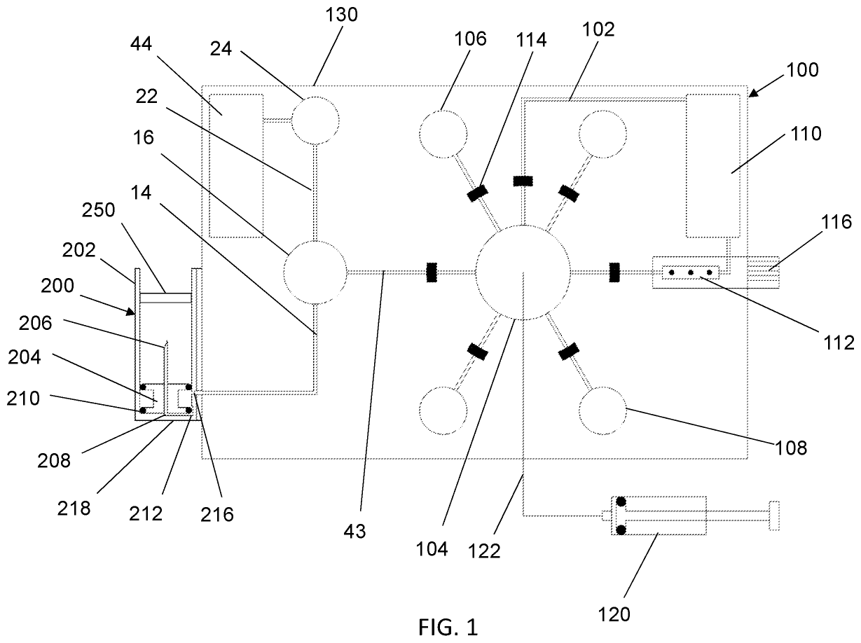

FIG. 1 is a schematic diagram showing a first liquid extraction device 200 in fluidic communication with a liquid handling device in the form of a cartridge 100. As shown in FIG. 1 the cartridge 100 includes a plurality of chambers in fluidic communication via a plurality of conduits 102. Specifically, the plurality of chambers includes a main chamber 104, a reagent chamber 106, a mixing chamber 108, a waste chamber 110, and a measurement chamber 112. The cartridge 100 also includes a plurality of valves 114, each of which controls fluid flow through a respective conduit 102. A sensor 116 is used to carry out a measurement (e.g. an electrochemical measurement) on a solution within the measurement chamber 112.

The flow of fluids between the chambers is controlled by an external pump 120 that is configured to apply a positive or negative pressure to the main chamber 104 via a pump conduit 122. The positive or negative pressure dispenses or aspirates fluid from one chamber to another, depending on which of the valves 114 is opened. For example, to aspirate reagent from the reagent chamber 106 to the main chamber 104 (e.g. for mixing with a sample), the valve 114 between the reagent chamber 106 and the main chamber 104 is opened, and a negative pressure is applied to the main chamber 104 by the pump 120.

The liquid extraction device 200 is in fluidic communication with the cartridge 100 via an inlet conduit 14. As explained in further detail below, the liquid extraction device 200 is configured to extract a liquid sample (e.g. blood) from a pierceable liquid storage container (e.g. a blood collection tube, not shown in FIG. 1). Once the liquid sample has been extracted from the liquid storage container, the liquid sample is transferred under pressure to a metering chamber 16 via the inlet conduit 14. The liquid sample can then be subsequently aspirated from the metering chamber 16 into the main chamber 104 via an outlet conduit 43, by application of a negative pressure using the pump 120.

The sample can then be combined with one or more reagents in the main chamber 104 by aspirating a reagent from the reagent chamber 106 to the main chamber 104. In order to mix the sample and reagent together, the solution may be repeatedly transferred between the main chamber 104 and the mixing chamber 108. The solution may then be dispensed to the measurement chamber 112, where an electrochemical measurement is carried out on the solution, using the sensor 116. Any waste solution from the main chamber 104 or the measurement chamber 112 may be transferred to the waste chamber 110.

The liquid extraction device 200 comprises a receptacle in the form of a cylinder 202 (or tube) in which a pierceable liquid storage container, such as a blood collection tube, is received. The liquid extraction device 200 also includes an actuatable liquid extraction mechanism in the form of a piston 204 that is actuatable within the cylinder 202 from a first liquid extraction mechanism configuration to a second liquid extraction mechanism configuration. In FIG. 1, the piston 204 is shown in the second liquid extraction mechanism configuration.

The piston 204 includes a sealing element in the form of an O-ring seal 210 configured to provide a seal between the piston 204 and the cylinder 202. The cylinder 202 includes a recess 212 configured to compromise the O-ring seal 210 by allowing air to flow around the O-ring seal 210, when the piston 204 is in the second configuration shown in FIG. 1.

The liquid extraction device 200 includes a liquid storage container interface (e.g. a blood collection tube interface) in the form of a needle 206 that is fixedly attached to the piston 204. The needle 206 is configured to pierce a liquid storage container (e.g. by piercing a septum of a blood collection tube). The needle 206 comprises a liquid extraction outlet 208 through which liquid extracted from the blood collection tube can flow.

The cylinder 202 also comprises an outlet 216 that allows liquid to be removed from the liquid extraction device 200 once it has been extracted from the blood collection tube. The outlet 216 is in fluidic communication with the inlet conduit 14, thereby allowing liquid to be transferred from the liquid extraction device 200 to the cartridge 100.

In the first liquid extraction mechanism, the piston 204 is located above the outlet 216 in the cylinder 202 (i.e. further from an end wall 218 of the cylinder 202 than shown in FIG. 1).

Together, the piston 204 and the cylinder 202 define a chamber. After connection of a blood collection tube to the needle 206, the volume of the chamber is reduced as the piston 204 is actuated from the first liquid extraction mechanism configuration to the second liquid extraction mechanism configuration. Once the piston 204 is actuated beyond the outlet 216, the reduction in volume of the chamber results in an increase in pressure of the air within the chamber, because the chamber is sealed by the O-ring seal 210. The increase in air pressure within the chamber forces air through the needle 206 and into the blood collection tube, which increases the pressure of a volume of gas within the blood collection tube. The increase in the pressure of air within the chamber and the blood collection tube continues as the piston 204 is actuated towards the second configuration.

Once the piston 204 is in the second configuration, the O-ring seal 210 is aligned with the recess 212 and is consequently compromised, meaning that the pressurised air within the chamber can flow around the O-ring seal 210. This reduces the pressure at the liquid extraction outlet 208, which is in fluidic communication with the chamber, thereby providing a pressure difference between the volume of gas within the blood collection tube, and the liquid extraction outlet 208. This difference in pressure forces liquid out of the blood collection tube via the needle 206, around the O-ring seal 210, and out of the liquid extraction device 200 via the outlet 216.

The liquid extraction device 200 comprises a safety mechanism 250 that is actuatable from a first safety mechanism configuration (shown in FIG. 1), in which the safety mechanism 250 conceals the needle 206, to a second safety mechanism configuration, in which the safety mechanism 250 reveals the needle 206. The safety mechanism 250 further comprises a blocking element (not shown) that prevents actuation of the safety mechanism 250 from the first safety mechanism configuration to the second safety mechanism configuration when the liquid extraction device 200 is in a first orientation (e.g. horizontal), but permits actuation of the safety mechanism 250 from the first safety mechanism configuration to the second safety mechanism configuration when the liquid extraction device 200 is in a second orientation (e.g. vertical).

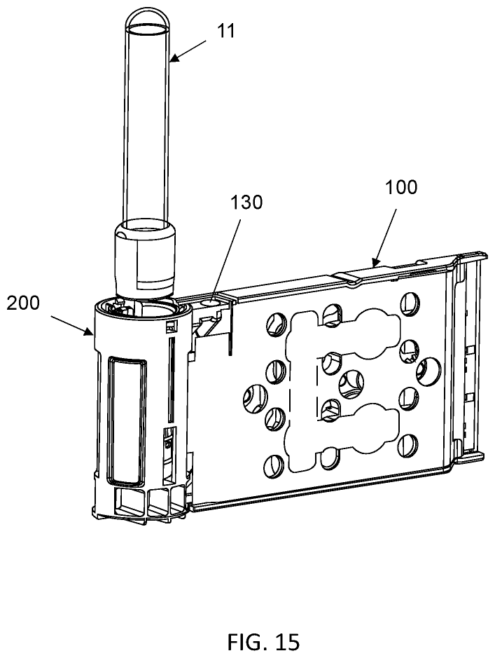

The cartridge 100 further comprises a sample adequacy control chamber 24 that provides a visual indication to a user that a sufficient amount of liquid has been extracted from the liquid storage container (e.g. blood collection tube). In particular, the sample adequacy control chamber 24 may provide a visual indication that a volume of liquid sufficient for a particular diagnostic test has been extracted. As shown, for example, in FIG. 15, the sample adequacy control chamber 24 is configured to provide the visual indication through an optically clear window 130 in a side wall of the cartridge 100 that is disposed upwards when the liquid extraction device is in a vertical orientation (i.e. when the liquid extraction device is used for extracting liquid from the liquid storage container).

The sample adequacy control chamber 24 forms part of a first flow path that is in fluidic communication with the inlet conduit 14 (which receives fluid extracted using the liquid extraction device 200). The cartridge 100 also includes a metering chamber 16 configured to store a specific volume of liquid. The first flow path includes the metering chamber 16, a connector conduit 22 providing a fluidic connection between the metering chamber 16 and the sample adequacy control chamber 24, the sample adequacy control chamber 24, and a vented waste chamber 44 in fluidic communication with the sample adequacy control chamber 24. The cartridge 100 further comprises a second flow path comprising an outlet conduit 43 extending from an outlet port in the metering chamber 16. The outlet conduit 43 allows liquid to be aspirated into the main chamber 104 of the cartridge 100. As explained in more detail below, alternative implementations may not include the metering chamber 16 or the connector conduit 22, in which case the outlet conduit 43 extends from an outlet port in a sample adequacy control chamber that is configured to meter a specific volume of liquid.

The second flow path (which includes the outlet conduit 43) provides a higher hydraulic resistance than the first flow path (which includes the sample adequacy control chamber 24, and optionally the metering chamber 16 and the connector conduit 22). This means that the flow rate of liquid through the first flow path is higher than the flow rate through the second flow path. The higher flow rate through the first flow path means that liquid flows into the sample adequacy control chamber 24 to provide the visual indication that a sufficient volume of liquid has been received, without filling the outlet conduit 43.

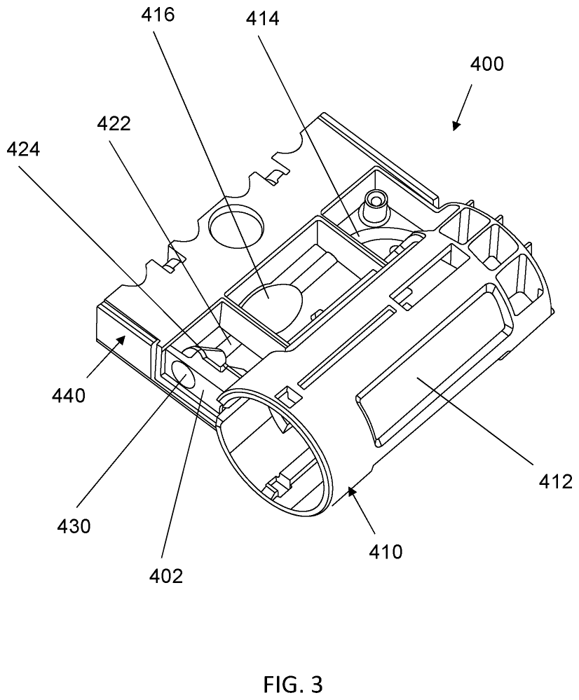

Liquid handling device implementations that include a sample adequacy control chamber are described in more detail with reference to FIGS. 3 to 16B.

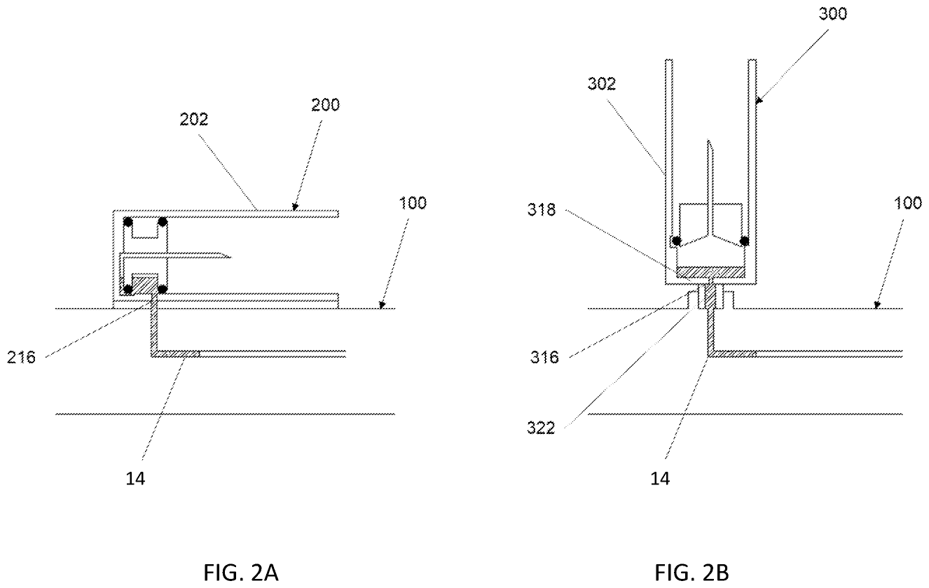

The outlet 216 of the liquid extraction device 200 shown in FIG. 1 is provided in a side wall of the cylinder 202. FIG. 2A shows the attachment between the first liquid extraction device 200 and the cartridge 100 in greater detail. Where the outlet 216 is provided in a side wall of the cylinder 202, the fluidic communication between the liquid extraction device 200 and the cartridge 100 may be provided by aligning the outlet 216 with a hole or via in the cartridge 100 that allows for the passage of fluid into the inlet conduit 14. The alignment of the outlet 216 with the hole or via may be provided by attaching the liquid extraction device 200 to the cartridge 100 using a layer of adhesive (e.g. a pressure-sensitive adhesive).

FIG. 2B shows an alternative attachment of a liquid extraction device to a cartridge, in which a second liquid extraction device 300 is attached to a cartridge (e.g. the cartridge 100). As with the liquid extraction device 200 shown in FIG. 2A, the liquid extraction device 300 comprises a cylinder 302 in which a pierceable liquid storage container, such as a blood collection tube, is received.

The liquid extraction device 300 also comprises a piston 304 that is moveable within the cylinder 302 from a first configuration to a second configuration. Attached to the piston 304 is a liquid storage container interface (e.g. needle 306) that provides a path for air to flow into the liquid storage container, and provides a path for liquid (e.g. blood) to flow out of the liquid storage container.

In contrast to the liquid extraction device 200 shown in FIG. 2A, however, the cylinder 302 comprises an outlet 316 that is provided in an end wall 318 of the cylinder 302. As shown in FIG. 2B, the outlet 316 in the cylinder 302 may be in fluidic communication with a connector 322 that protrudes from the base of the cylinder 302. The connector 322 allows the liquid extraction device 300 to be attached to the cartridge by a push-fit attachment (e.g. by inserting the connector 322 into a corresponding hole or aperture in the cartridge), or using a luer lock, or by any other suitable type of fluidic connector.

It will be appreciated that these attachment mechanisms are not specific to the locations of the outlet in the cylinder of the liquid extraction device. In particular, the liquid extraction device 300 shown in FIG. 2B may be attached to the cartridge using an adhesive, and the liquid extraction device 200 shown in FIG. 2A may comprise a connector protruding from the side wall of the cylinder 202, that allows for attachment to the cartridge 100 using a push-fit or luer lock mechanism, or any other suitable type of fluidic connector. The liquid extraction devices 200, 300 shown in FIGS. 2A and 2B may alternatively be integrated within the cartridge. For example, the cylinders 202, 302 may be moulded (or otherwise manufactured) together with the cartridge 100.

Described below are implementations of a liquid handling device comprising a sample adequacy control chamber that allows the presence of absence of a volume of liquid to be determined. The liquid handling device implementations described below each comprise an inlet conduit configured to receive a liquid sample. The inlet conduit may be in fluidic communication with an outlet from a liquid extraction device for extracting liquid from a liquid storage container (e.g. as described above with reference to FIGS. 1, 2A and 2B), such that the liquid sample is extracted from the liquid storage container and transferred to the inlet conduit of the liquid handling device. The liquid extraction device may be part of the same liquid handling device as the liquid handling device that comprises the sample adequacy control chamber (e.g. part of a cartridge, such as a microfluidic cartridge, used for performing a diagnostic test on the liquid sample). Alternatively, the inlet conduit may receive the liquid sample from a syringe or pipette, in which case the liquid handling device may not comprise the liquid extraction device.

The liquid handling device implementations described herein comprise two flow paths in fluidic communication with the inlet conduit. A first flow path comprises the sample adequacy control chamber, whereas a second flow path comprises an outlet conduit that allows liquid to be aspirated, for example, to other fluidic components of a cartridge. The second flow path is configured to provide a higher hydraulic resistance than the first flow path. This means that liquid flows through the first flow path (and consequently into the sample adequacy control chamber), in preference to the second flow path.

Hydraulic resistance (Rn) in a system can be categorised into two components: friction resistance and local (separation) resistance. Friction resistance results from momentum transfer to the surrounding walls, and can be calculated using the Darcy-Weisbach empirical equation. Local resistance is caused by the dissipation of mechanical energy when the direction of flow is changed, owing to the formation of eddies. Local resistances can be caused by inlet and outlet features, bends and flow adapters along the fluid flow path. Such local resistances can be calculated using theories on pipe constrictions or orifice discharge to the atmosphere.

The total hydraulic resistance along a particular flow path can be calculated by summing the friction resistances and the local resistances:

$${R}_{{h}_{total}} = \sum {R}_{h}^{frictíon} + \sum {R}_{h}^{local} \qquad Equation 1$$

In networks of conduits, equivalent resistances can be calculated using summations in series. Therefore, for channels in series:

$${{R}_{h}^{frictíon}}_{total} = \sum {R}_{h}^{frictíon} i \qquad Equation 2$$

From the above, it will be appreciated that the hydraulic resistance of a particular flow path may be tuned by adjusting the friction resistance or local resistance of fluidic components along the flow path. In the liquid handling device implementations described herein, the second flow path is configured so that it provides a higher hydraulic resistance than the first flow path.

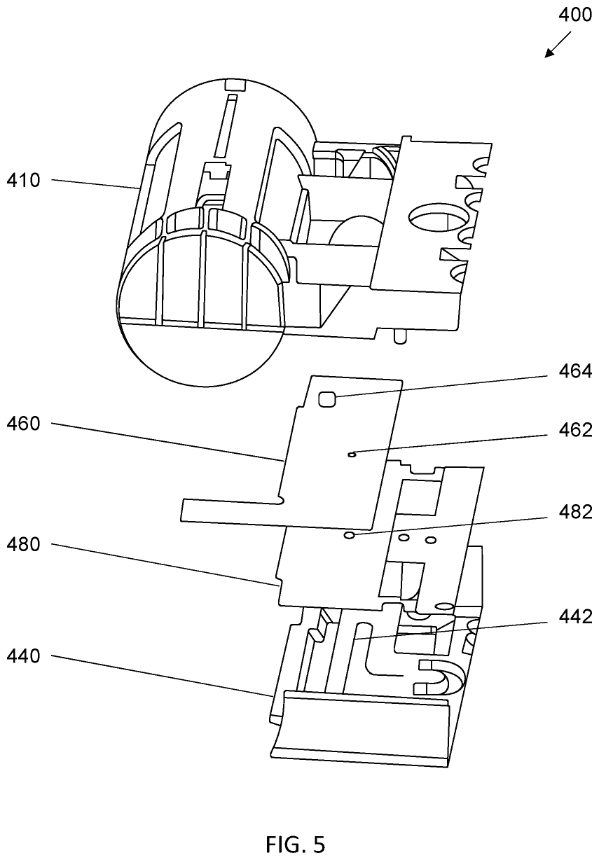

FIGS. 3-6 show a liquid handling device 400 comprising a sample adequacy control chamber 424. The liquid handling device 400 allows the presence or absence of a volume of liquid within the sample adequacy control chamber 424 to be determined. As best shown in FIG. 5, the liquid handling device 400 comprises a first moulded part 410, a second moulded part 440, a first sealing layer 460 configured to seal one or more fluidic features in the first moulded part 410, and a second sealing layer 480 configured to seal one or more fluidic features in the second moulded part 440. The first sealing layer 460 and the second sealing layer 480 may alternatively be provided as a single sealing layer that seals fluidic features in both the first moulded part 460 and the second moulded part 440. One or more of the first moulded part 410 and the second moulded part 440 may be formed from, for example, polycarbonate or polypropylene. The components of the liquid handling device 400 are assembled, for example, using an adhesive such as a pressure-sensitive adhesive. The first moulded part 410 and second moulded part 440 may define fluidic components within a cartridge used for carrying out a diagnostic test (i.e. where the liquid handling device 400 is integrated into such a cartridge). The liquid handling device 400 may alternatively be a standalone module that can be fluidically coupled with such a cartridge using a push-fit attachment, luer lock, or any other suitable type of fluidic connector.

Returning to FIG. 3, it can be seen that the liquid handling device 400 comprises a cylinder 412 defined by the first moulded part 410. The cylinder 412 may be a cylinder of one of the liquid extraction devices 200, 300 described above with reference to FIGS. 1, 2A and 2B. That is, the cylinder 412 may comprise components of the liquid extraction devices 200, 300 that are used for extracting liquid from a liquid storage container.

The liquid handling device 400 further comprises an inlet conduit 414 providing a fluidic connection to the cylinder 412. The inlet conduit 414 is defined by the first moulded part 410 and the first sealing layer 460.

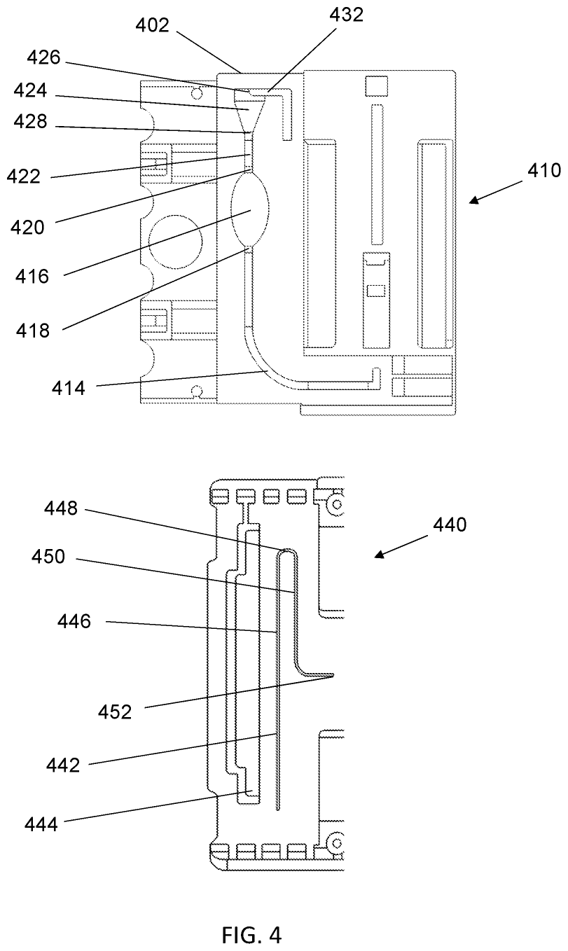

The inlet conduit 414 is in fluidic communication with a metering chamber 416 that is also defined by the first moulded part 410 and the first sealing layer 460. The metering chamber 416 is configured to store a specific volume of liquid, and comprises a metering chamber inlet port 418 (see FIG. 4) that provides the fluidic connection to the inlet conduit 414. The metering chamber 416 comprises a first metering chamber outlet port, shown in FIG. 5 in the form of a hole 462 provided in the first sealing layer 460 and a corresponding hole 482 provided in the second sealing layer 480.

The first metering chamber outlet port provides a fluidic connection between the metering chamber 416 and a U-shaped outlet conduit 442 (shown in FIG. 4) defined by the second moulded part 440 and the second sealing layer 480. The outlet conduit 442 is vented, and allows liquid to be aspirated from the metering chamber 416 to another fluidic component of the liquid handling device 400. For example, if the liquid handling device 400 is integrated within a cartridge (e.g. the cartridge 100 shown in FIG. 1), the outlet conduit 442 may allow liquid to be aspirated into a chamber of the cartridge (e.g. the main chamber 104 in FIG. 1). The outlet conduit 442 is described in further detail below with reference to FIG. 4.

Returning to FIG. 3, it can be seen that the metering chamber 416 further comprises a second metering chamber outlet port 420 that provides a fluidic connection to a connector conduit 422. The connector conduit 422 is defined by the first moulded part 410 and the first sealing layer 460. The connector conduit 422 provides a fluidic connection between the metering chamber 416 and the sample adequacy control chamber 424 defined by the first moulded part 410 and the first sealing layer 460. The connector conduit 422 has a smaller cross-sectional area than the metering chamber 416 and the sample adequacy control chamber 424, meaning that the connector conduit 422 defines a constriction between the metering chamber 416 and the sample adequacy control chamber 424. The constriction defined by the connector conduit 422 reduces the volume of the metering chamber 416 that is viewable through the sample adequacy control chamber 424.

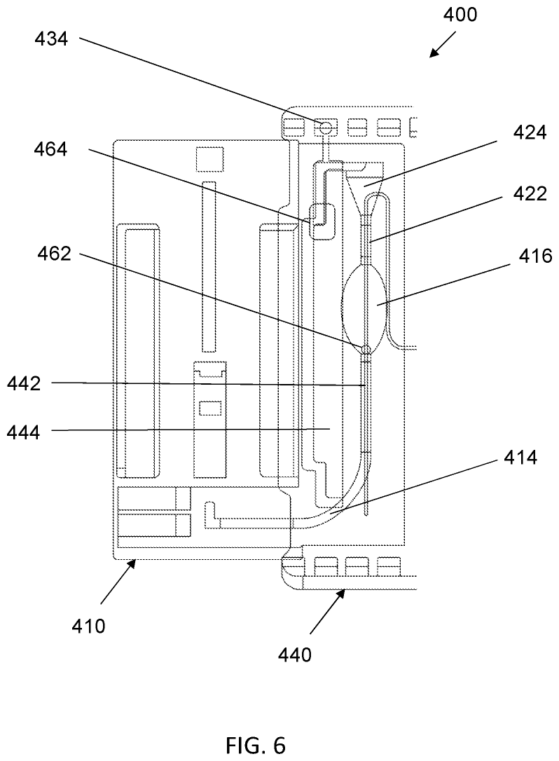

As best shown in FIG. 4, the sample adequacy control chamber 424 has a conical shape with a wide upper end 426 and a narrower lower end 428 that provides the fluidic connection to the connector conduit 422. The lower end 428 therefore provides a sample adequacy control chamber inlet port to the sample adequacy control chamber 424. When the liquid handling device 400 is used for allowing the presence or absence of a volume of liquid within the sample adequacy control chamber 424 to be determined, the liquid handling device 400 is in the orientation shown in FIG. 6. In this orientation, the sample adequacy control chamber 424 is positioned above the metering chamber 416, meaning that the sample adequacy control chamber 424 is downstream from the metering chamber 416.

The sample adequacy control chamber 424 allows the presence or absence of a volume of liquid within the sample adequacy control chamber 424 to be determined. In the example shown in FIGS. 3-6, the liquid handling device 400 comprises an indicator region in the form of a transparent or semi-transparent viewing window 430 (shown in FIG. 3), provided in a wall 402 of the liquid handling device 400. The wall 402 is defined by the first moulded part 410. The sample adequacy control chamber 424 is viewable through the indicator region in the liquid handling device 400 (i.e. through the viewing window 430).

When the liquid handling device 400 is in use (i.e. to allow the presence or absence of the volume of liquid within the sample adequacy control chamber 424 to be determined), the viewing window 430 is positioned above the sample adequacy control chamber 424, as shown in FIG. 6. In other words, the indicator region is downstream from the sample adequacy control chamber inlet port (i.e. the lower end 428 of the sample adequacy control chamber 424).

Further, in the orientation shown in FIG. 6, the upper end 426 of the sample adequacy control chamber 424 is positioned above the lower end 428 of the sample adequacy control chamber 424. In addition, the second metering chamber outlet port 420 is positioned above the first metering chamber outlet port, which is in turn positioned above the metering chamber inlet port 418. In other words, the distance between the upper end 426 of the sample adequacy control chamber 424 and the indicator region is less than the distance between the lower end 428 of the sample adequacy control chamber 424. Also, the distance between the second metering chamber outlet port 420 and the indicator region (viewing window 430) is less than the distance between the first metering chamber outlet port and the indicator region, and the distance between the first metering chamber outlet port and the indicator region is less than the distance between the metering chamber inlet port 418 and the indicator region.

The sample adequacy control chamber 424 further comprises a waste outlet 432 (shown in FIG. 4) that provides a fluidic connection to a waste chamber 444 defined by the second moulded part 440 and the second sealing layer 480. The waste outlet 432 is provided between the upper end 426 of the sample adequacy control chamber 424 and the lower end 428 of the sample adequacy control chamber 424. The waste outlet 432 is provided in the form of an overflow from the sample adequacy control chamber 424, meaning that once the liquid level within the sample adequacy control chamber 424 reaches the level of the waste outlet 432, any additional liquid overflows into the waste chamber 444 via the waste outlet 432. The fluidic connection between the waste outlet 432 and the waste chamber 444 is provided by an opening 464 in the first sealing layer 460 (shown in FIG. 5), and a corresponding opening (not shown) in the second sealing layer 480.

As best shown in FIG. 6, the waste chamber 444 is vented via a waste chamber vent 434 provided in the second sealing layer 480. The fluidic connection between the waste chamber 444 and the waste chamber vent 434 is provided by a vent hole 466 in the first sealing layer 460 (shown in FIG. 5), and a corresponding opening (not shown) in the second sealing layer 480. The waste chamber vent 434 prevents pressurisation of any fluids within the waste chamber 444.

As best shown in FIG. 4, the U-shaped outlet conduit 442 comprises a first outlet conduit section 446 that extends from the first metering chamber outlet port in the direction of the sample adequacy control chamber 424. In other words, the first outlet conduit section 446 extends from the first metering chamber outlet port towards the indicator region (i.e. towards the wall 402 in which the viewing window 430 is provided). As shown in FIG. 6, which shows the orientation in which the liquid handling device 400 is used, the first outlet conduit section 446 extends vertically in use from the first metering chamber outlet port towards the wall 402 (i.e. in the direction of the indicator region).

The outlet conduit 442 further comprises a U-bend 448 connecting the first outlet conduit section 446 to a second outlet conduit section 450 that runs parallel to the first outlet conduit section 446 before curving away from the first outlet conduit section 446 and running perpendicular to the first outlet conduit section 446. After running perpendicular to the first outlet conduit section 446, the second outlet conduit section 450 terminates at an end 452 of the outlet conduit 442.

The liquid handling device 400 therefore comprises two flow paths, each of which is in fluidic communication with the inlet conduit 414. A first flow path comprises the portion of the metering chamber 416 downstream of the first metering chamber outlet port, the second metering chamber outlet port 420, the connector conduit 422, the sample adequacy control chamber 424, the waste outlet 432, and the waste chamber 444. A second flow path comprises the first metering chamber outlet port and the outlet conduit 442. The junction between the two flow paths is within the metering chamber 416. The first metering chamber outlet port therefore provides an inlet to the second flow path.

The second flow path provides a higher hydraulic resistance than the first flow path. To provide the higher hydraulic resistance of the second flow path, the outlet conduit 442 is narrower than (i.e. has a smaller cross-sectional area than) each of the inlet conduit 414 and the metering chamber 416 and has a cross-sectional area that is smaller than or equal to that of the connector conduit 422. The smaller cross-sectional area of the outlet conduit 442 provides increased hydraulic resistance over the inlet conduit 414, metering chamber 416 and connector conduit 422. In addition, the outlet conduit 442 is longer than the connector conduit 422, which also serves to increase its hydraulic resistance. Further, when liquid is forced into the first outlet conduit section 446, a column of liquid is formed in the first outlet conduit section 446. This column of liquid increases the hydraulic resistance to further liquid flow into the second flow path. The hydraulic resistance of the second flow path is also higher than the hydraulic resistance of the sample adequacy control chamber 424.

In use, the liquid handling device 400 is initially orientated in the orientation shown in FIG. 6. In this orientation, liquid may be extracted from a liquid storage container using a liquid extraction mechanism disposed within the cylinder 412 (e.g. as described with reference to FIG. 1), resulting in a flow of liquid into the inlet conduit 414 under pressure. As discussed above, the inlet conduit 414 may alternatively receive a flow of liquid from, for example, a pipette or syringe.

The pressurised liquid flows through the inlet conduit 414 and into the metering chamber 416, filling the metering chamber 416. At the same time, some liquid is pushed into the second flow path (i.e. through the first metering chamber outlet port and into the outlet conduit 442). However, as a result of the higher hydraulic resistance of the second flow path, the liquid has a tendency to flow through the first flow path and thereby fill the metering chamber 416, meaning that only a small amount of liquid is pushed into the outlet conduit 442. The flow of liquid into the second flow path is further slowed by the pressure head of any liquid within the first outlet conduit section 446, when the liquid handling device 400 is in the orientation shown in FIG. 6 (i.e. when the viewing window 430 is oriented upwards, meaning that the viewing window 430 is higher than the inlet conduit 414). In addition, the flow of liquid through the first metering chamber outlet port (i.e. the inlet to the second flow path, provided by the holes 462, 482) results in a drop in pressure of the liquid, further reducing the tendency of liquid to flow into the second flow path.

During filling of the metering chamber 416, the proportion of the metering chamber 416 that is viewable via the viewing window 430 in the sample adequacy control chamber 424 is minimised by the smaller cross-sectional area of the connector conduit 422, which acts as a visual constriction. The constriction provided by the connector conduit 422 reduces the risk of a user falsely identifying the liquid in the metering chamber 416 as the volume of liquid in the sample adequacy control chamber 424. After the metering chamber 416 is filled, the constriction provided by the connector conduit 422 also helps to prevent air bubbles from entering the metering chamber 416 (e.g. if the liquid handling device 400 is moved or shaken).

Once the metering chamber 416 is filled, the pressurised liquid continues to flow through the first flow path. In particular, the pressurised liquid flows through the constriction provided by the connector conduit 422, and starts to fill the sample adequacy control chamber 424. At this point, a user can view the volume of liquid within the sample adequacy control chamber 424 via the viewing window 430 in the wall 402 of the liquid handling device 400. The conical shape of the sample adequacy control chamber 424 means that the visual indication of the volume of liquid increases in diameter as the sample adequacy control chamber 424 is filled. Once the user determines the presence of a volume of liquid within the sample adequacy control chamber 424, the flow of liquid into the inlet conduit 414 can be stopped. For example, the user can stop applying a force to a blood collection tube from which liquid is extracted using a liquid extraction mechanism disposed within the cylinder 412. This is because the user knows that the metering chamber 416 must have been filled, in order for there to be liquid within the sample adequacy control chamber 424. Consequently, the user knows that a sufficient volume of liquid required for a particular diagnostic test (i.e. the volume of the metering chamber 416) has been received in the liquid handling device 400. The user also knows that the blood collection tube can be removed from the cylinder 412, and that a diagnostic test can be carried out.

Once the liquid level within the sample adequacy control chamber 424 reaches the waste outlet 432, any additional liquid introduced into the sample adequacy control chamber 424 flows over the overflow provided by the waste outlet 432, and subsequently flows into the vented waste chamber 444.

The higher relative hydraulic resistance provided by the second flow path encourages liquid flow through the first flow path and into the sample adequacy control chamber 424, rather than into the outlet conduit 442. This means that a user is able to determine that a sufficient volume of liquid has been received in the liquid handling device 400 for the particular diagnostic test, without unintentional liquid flow into other fluidic components of a cartridge, for example.

To increase the hydraulic resistance provided by the second flow path, the extent of the first outlet conduit section 446 in the direction of the indicator region (i.e. viewing window 430) is maximised. For example, the first outlet conduit section 446 may extend to the same height as the lower end 428 of the sample adequacy control chamber 424 (when viewed from the orientation shown in FIG. 6). Alternatively, the first outlet conduit section 446 may extend further than the lower end 428, or further than the waste outlet 432, to further discourage liquid flow into the outlet conduit 442 by maximising the potential pressure head provided by liquid within the first outlet conduit section 446 when the liquid handling device 400 is in the orientation shown in FIG. 6. This reduces the tendency for liquid to flow over the U-bend 448 in the outlet conduit 442, thereby reducing unintentional aspiration of liquid (e.g. into a cartridge).

Instead of the presence or absence of the volume of liquid being determined by a user, a sensor (e.g. an optical sensor) in an external device may be used to determine the presence or absence of the volume of liquid. For example, the liquid handling device 400 may be implemented in a cartridge used for carrying out a diagnostic test. The cartridge may be received in an analyser device, which controls the flow of fluids within the cartridge in accordance with a diagnostic protocol, in order to carry out the diagnostic test. In such an example, the presence or absence of the volume of liquid may be detected using an optical sensor located within the analyser device. If the optical sensor detects the absence of a volume of liquid within the sample adequacy control chamber 424, then the diagnostic test may be stopped immediately. This is advantageous in time-critical diagnostic tests, because a user does not need to wait for the diagnostic test to be run and for an error message to be output, meaning that a user can re-attempt the diagnostic test using a separate cartridge. The analyser device may include alternative detection means (e.g. electrochemical detection means) to detect the presence or absence of the volume of liquid within the sample adequacy control chamber 424, instead of using an optical sensor.

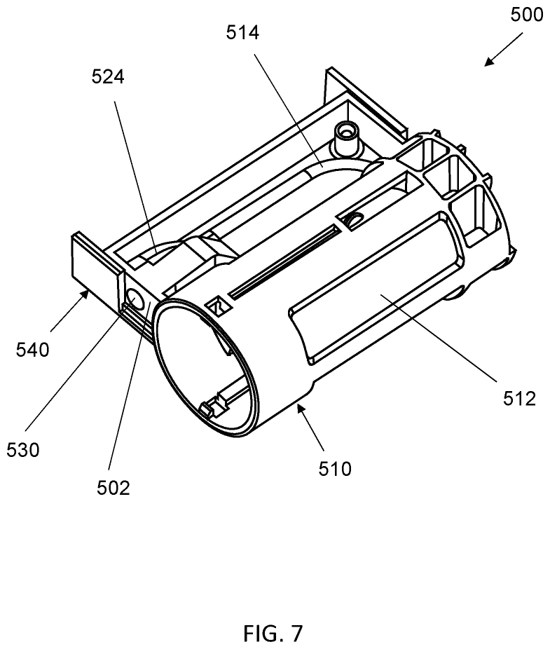

FIGS. 7-10 show an alternative liquid handling device 500 comprising a sample adequacy control chamber 524. In contrast to the liquid handling device 400 shown in FIGS. 3-6, the metering functionality of the liquid handling device 500 is provided by the sample adequacy control chamber 524, meaning that there is no separate metering chamber.

The liquid handling device 500 comprises a first moulded part 510, second moulded part 540, first sealing layer 560 and second sealing layer 580 (optionally combined as a single sealing layer), each having the same functionality as the corresponding features of the liquid handling device 400 shown in FIGS. 3-6, except for the differences explained below.

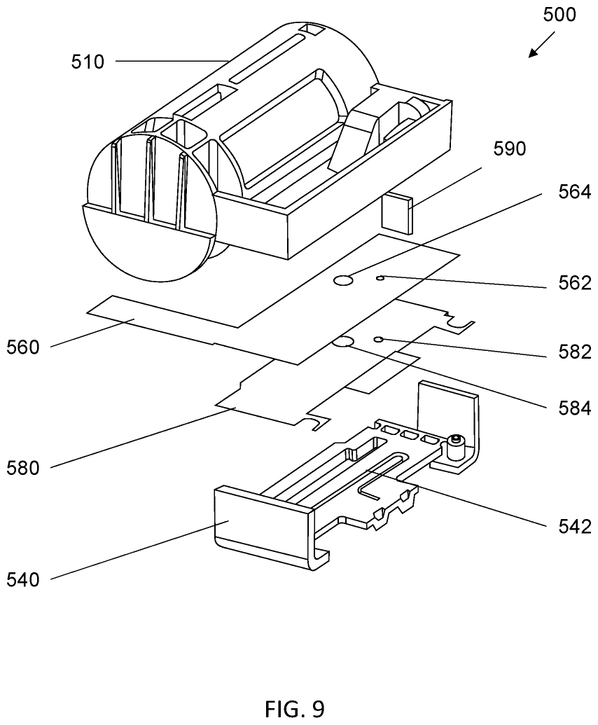

The liquid handling device 500 comprises an inlet conduit 514 providing a fluidic connection to a cylinder 512. The inlet conduit 514 is in fluidic communication with the sample adequacy control chamber 524. The sample adequacy control chamber 524 comprises a sample adequacy control chamber outlet port, shown in FIG. 9 in the form of a hole 562 provided in the first sealing layer 560, and a corresponding hole 582 provided in the second sealing layer 580. The sample adequacy control chamber outlet port provides a fluidic connection between the sample adequacy control chamber 524 and an outlet conduit 542 that allows liquid to be aspirated from the sample adequacy control chamber 524 to another fluidic component of the liquid handling device 500. The outlet conduit 542 has the same construction as the outlet conduit 442 of the liquid handling device 400 shown in FIGS. 3-6.

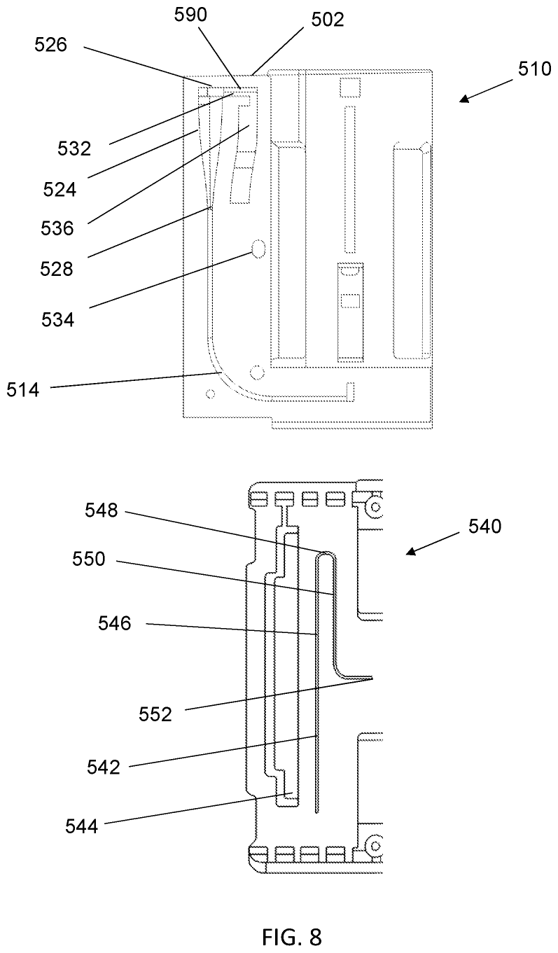

Returning to FIG. 8, it can be seen that the sample adequacy control chamber 524 has a conical shape with a wide upper end 526 and a narrower lower end 528. The lower end 528 provides a sample adequacy control chamber inlet port to the sample adequacy control chamber 524. The sample adequacy control chamber inlet port provides the fluidic connection to the inlet conduit 514.

The sample adequacy control chamber 524 of the liquid handling device 500 comprises a pad 590 of porous or absorbent material that is exposed to liquid within the sample adequacy control chamber 524. The pad 590 is visible through an indicator region of the liquid handling device 500. Specifically, in the example shown in FIGS. 7 to 10, the pad 590 is visible through a transparent or semi-transparent viewing window 530 provided in the wall 502 of the liquid handling device 500. The pad 590 provides a visual indicator once liquid has contacted the pad 590. For example, the user may be able to see the liquid once it passes through a pad of porous material, or once it is absorbed by a pad of absorbent material. As another example, the pad 590 may change colour once it absorbs liquid.

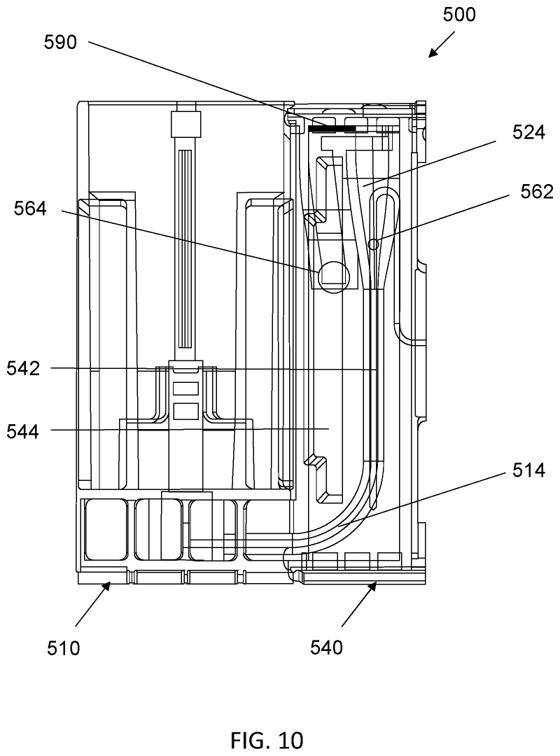

When the liquid handling device 500 is in use (i.e. for allowing the presence or absence of a volume of liquid within the sample adequacy control chamber 524 to be determined), the liquid handling device 500 is in the orientation shown in FIG. 10. In this orientation, the sample adequacy control chamber outlet port is positioned above the sample adequacy control chamber inlet port (i.e. the lower end 528). In other words, the distance between the sample adequacy control chamber outlet port and the indicator region (i.e. viewing window 530) is less than the distance between the sample adequacy control chamber inlet port and the indicator region.

In the liquid handling device 500, the second moulded part 540 is extended (when compared to the second moulded part 440 of the liquid handling device 400), so that it overlaps the upper end of the sample adequacy control chamber 524 (when viewed in the orientation shown in FIG. 10). This means that the second moulded part 540 occludes the liquid within the inlet conduit 514, such that liquid within the inlet conduit 514 is not visible through the wall 502 of the liquid handling device 500.

As shown in FIG. 8, the sample adequacy control chamber 524 comprises a waste outlet 532 that provides a fluidic connection to a waste chamber 544, which is vented via a waste chamber vent 534. The waste outlet 532 is provided between the upper end 526 of the sample adequacy control chamber 524 and the lower end 528 of the sample adequacy control chamber 524. In particular, the waste outlet 532 is provided above the fill level of a specific volume of liquid required for a diagnostic test. The waste outlet 532 is provided in the form of an overflow from the sample adequacy control chamber 524, meaning that once the sample adequacy control chamber 524 contains the specific volume of liquid required for the diagnostic test, any additional liquid overflows into the waste chamber 544 via the waste outlet 532.

The sample adequacy control chamber 524 further comprises an overspill sub-chamber 536 in fluidic communication with the waste outlet 532 and an opening 564 in the first sealing layer 560 (and corresponding opening 584 in the second sealing layer 580) that provides a fluidic connection to the waste chamber 544.

The waste outlet 532 provides a constricted flow passage into the overspill sub-chamber 536. The pad 590 of porous or absorbent material is positioned above the waste outlet 532. This means that liquid passing through the constricted flow passage provided by the waste outlet 532 passes over the pad 590 of porous or absorbent material. Once the liquid has passed through the waste outlet 532, it flows into the overspill sub-chamber 536 and subsequently through the openings 564, 584 and into the waste chamber 544.

The liquid handling device 500 therefore comprises two flow paths, each of which is in fluidic communication with the inlet conduit 514. A first flow path comprises the portion of the sample adequacy control chamber 524 that is downstream of the sample adequacy control chamber outlet port, the waste outlet 532, the overspill sub-chamber 536, and the waste chamber 544. A second flow path comprises the sample adequacy control chamber outlet port and the outlet conduit 542. The junction between the flow paths is within the sample adequacy control chamber 524, meaning that the sample adequacy control chamber outlet port provides an inlet to the second flow path. As with the liquid handling device 400 described above, the second flow path of the liquid handling device 500 provides a higher hydraulic resistance than the first flow path.

In use, the liquid handling device 500 is initially orientated in the orientation shown in FIG. 10. The inlet conduit 514 receives a flow of pressurised liquid in this orientation.

The pressurised liquid flows through the inlet conduit 514 and into the sample adequacy control chamber 524. The liquid flows into the first flow path as a consequence of its lower hydraulic resistance, thereby filling the sample adequacy control chamber 524 to the level of the waste outlet 532. This means that the sample adequacy control chamber 524 contains the volume of liquid required for the diagnostic test.

At the same time, some liquid is pushed into the second flow path through the sample adequacy control chamber outlet port, and into the outlet conduit 542. However, as a result of the higher hydraulic resistance of the second flow path, the liquid has a tendency to flow through the first flow path and thereby fill the sample adequacy control chamber 524, meaning that only a small amount of liquid is pushed into the outlet conduit 542.

During filling of the sample adequacy control chamber 524, the liquid within the sample adequacy control chamber 524 is not viewable through the wall 502 of the liquid handling device 500. Once liquid fills the sample adequacy control chamber 524 to the level of the waste outlet 532, liquid flows through the waste outlet 532 and over the pad 590 of porous or absorbent material, which is visible through the viewing window 530.

Once liquid has contacted the pad 590, the user is able to determine the presence of a volume of liquid within the sample adequacy control chamber 524. In particular, the user determines that a sufficient volume of liquid required for a particular diagnostic test has been received in the liquid handling device 500.

The liquid that flows through the waste outlet 532 passes into the overspill sub-chamber 536 under gravity, and subsequently flows into the vented waste chamber 544.

The lack of a separate metering chamber and connector conduit means that there is no constriction at the inlet to the sample adequacy control chamber 524 of the liquid handling device 500. This means that there is a lower back pressure on the outlet conduit 542, compared to the back pressure on the outlet conduit 442 of the liquid handling device 400 shown in FIGS. 3-6. In addition, by using the sample adequacy control chamber 524 to meter a specific volume of liquid, a lower volume of blood is required in order to indicate the presence or absence of a sufficient volume of liquid, when compared with the liquid handling device 400. Consequently, the liquid handling device 500 requires a reduced volume of sample in order to perform a diagnostic test, when compared with the liquid handling device 400.

The constriction provided by the waste outlet 532 prevents air bubbles from entering the sample adequacy control chamber 524 after filling of the sample adequacy control chamber 524 (e.g. if the liquid handling device is moved or shaken).

As a modification to the liquid handing device 500 described above, the pad 590 of porous or absorbent material may not be used. In this case, the visual indication of the presence of liquid within the sample adequacy control chamber 524 would be provided by the flow of liquid through the waste outlet 532, which is visible through the viewing window 530.

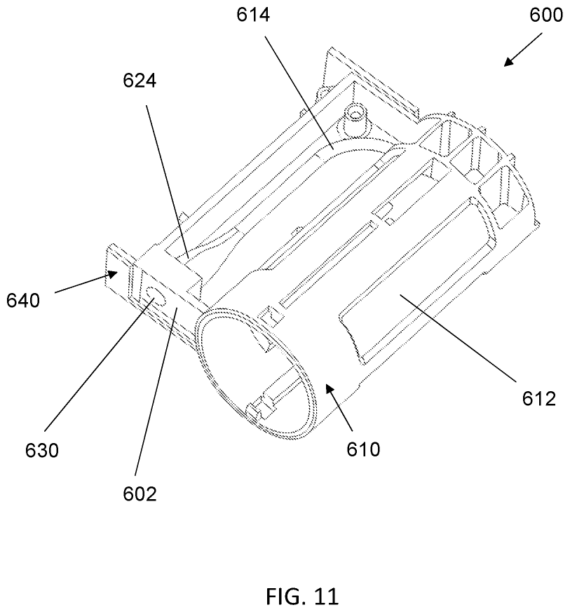

FIGS. 11-14 show a further alternative liquid handling device 600 comprising a sample adequacy control chamber 624. In contrast to the liquid handling device 500 shown in FIGS. 7-10, the waste outlet from the sample adequacy control chamber 624 of the liquid handling device 600 flows directly into the waste chamber, without flowing through a constricted flow passage.

The liquid handling device comprises a first moulded part 610, second moulded part 640, first sealing layer 660 and second sealing layer 680 (optionally combined as a single sealing layer), each having the same functionality as the corresponding features of the liquid handling device 400 shown in FIGS. 3-6, except for the differences explained below.

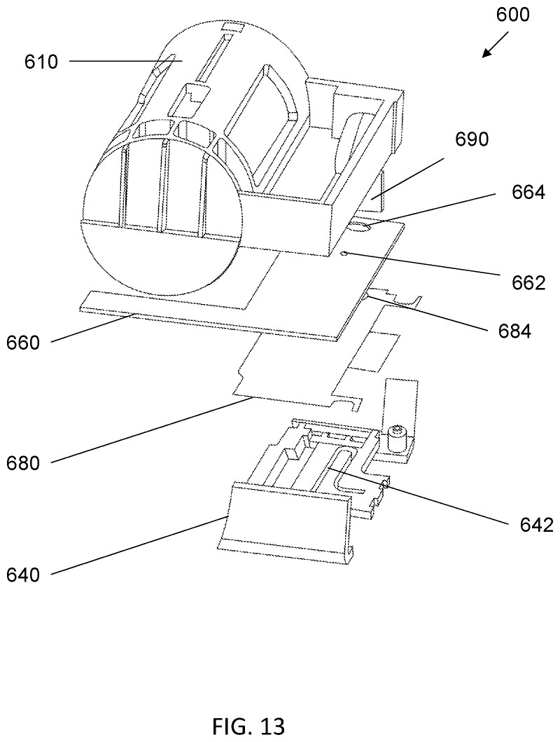

As with the liquid handling device 500 shown in FIGS. 7-10, the liquid handling device 600 shown in FIGS. 11-14 comprises an inlet conduit 614 providing a fluidic connection to a cylinder 612. The inlet conduit 614 is in fluidic communication with the sample adequacy control chamber 624. The sample adequacy control chamber 624 comprises a sample adequacy control chamber outlet port, shown in FIG. 13 in the form of a hole 662 provided in the first sealing layer 660, and a corresponding hole 682 provided in the second sealing layer 680. The sample adequacy control chamber outlet port provides a fluidic connection between the sample adequacy control chamber 624 and an outlet conduit 642 that allows liquid to be aspirated from the sample adequacy control chamber 624 to another fluidic component of the liquid handling device 600. The outlet conduit 642 has the same construction as the outlet conduit 442 of the liquid handling device 400 shown in FIGS. 3-6.

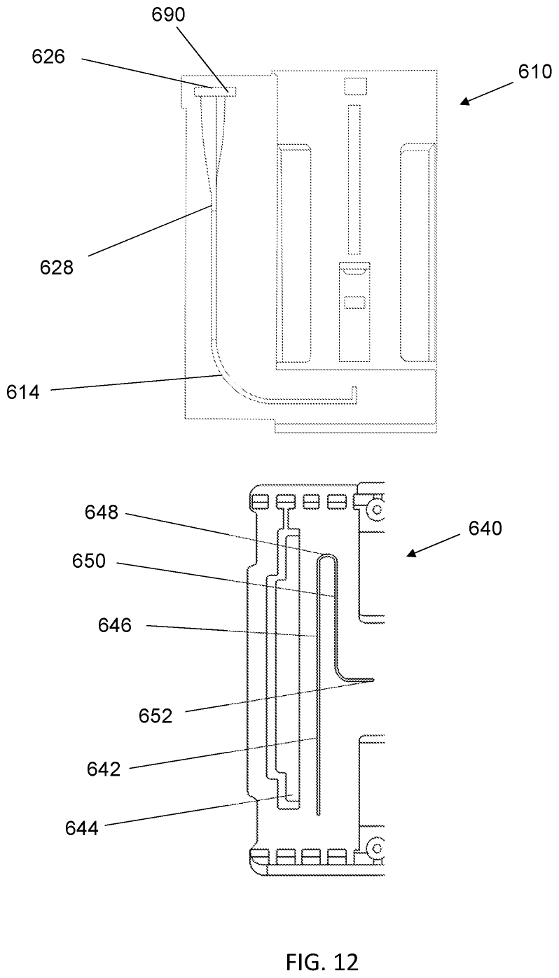

Returning to FIG. 12, it can be seen that the sample adequacy control chamber 624 has a conical shape with a wide upper end 626 and a narrower lower end 628. The lower end 628 provides a sample adequacy control chamber inlet port to the sample adequacy control chamber 624. The sample adequacy control chamber inlet port provides the fluidic connection to the inlet conduit 614.

The sample adequacy control chamber 624 of the liquid handling device 600 comprises a pad 690 of porous or absorbent material that is exposed to liquid within the sample adequacy control chamber 624. The pad 690 is visible through an indicator region of the liquid handling device 600. Specifically, in the example shown in FIGS. 11 to 14, the pad 690 is visible through a transparent or semi-transparent viewing window 630 provided in the wall 602 of the liquid handling device 600. The pad 690 provides a visual indicator once liquid has contacted the pad 690. For example, the user may be able to see the liquid once it passes through a pad of porous material, or once it is absorbed by a pad of absorbent material. As another example, the pad 690 may change colour once it absorbs liquid.

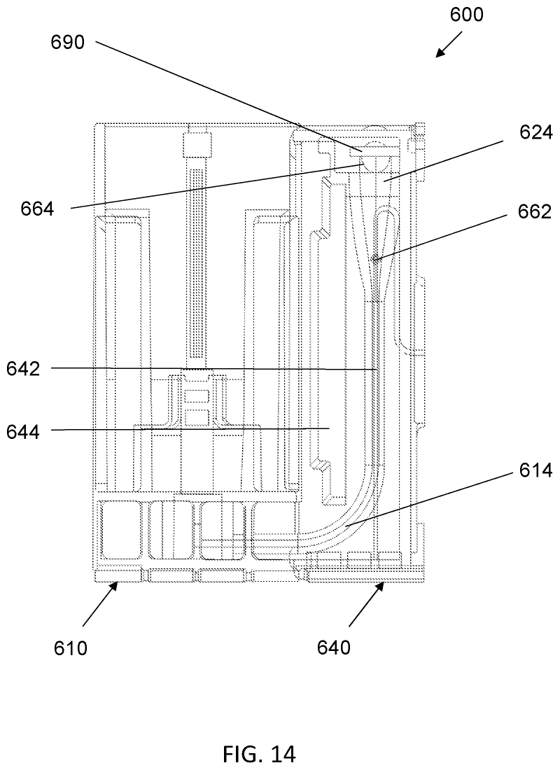

When the liquid handling device 600 is in use (i.e. for allowing the presence or absence of a volume of liquid within the sample adequacy control chamber 624 to be determined), the liquid handling device 600 is in the orientation shown in FIG. 14. In this orientation, the sample adequacy control chamber outlet port is positioned above the sample adequacy control chamber inlet port (i.e. the lower end 628). In other words, the distance between the sample adequacy control chamber outlet port and the indicator region (i.e. viewing window 630) is less than the distance between the sample adequacy control chamber inlet port and the indicator region.

The sample adequacy control chamber 624 comprises a waste outlet that provides a fluidic connection to a waste chamber 644 having the same construction as the waste chamber 444 of the liquid handling device 400. The waste chamber 644 is vented via a waste chamber vent (not shown). The waste outlet is provided in the form of an opening 664 in the first sealing layer 660 and a corresponding opening 684 in the second sealing layer 680. The waste outlet is provided between the upper end 626 of the sample adequacy control chamber 624 and the lower end 628 of the sample adequacy control chamber 624. In particular, the waste outlet is provided above the fill level of a specific volume of liquid required for a diagnostic test. The waste outlet (i.e. openings 664, 684) is provided in the form of an overflow from the sample adequacy control chamber 624, meaning that once the sample adequacy control chamber 624 contains the specific volume of liquid required for the diagnostic test, any additional liquid overflows into the waste chamber 644 via the waste outlet.

The pad 690 of porous or absorbent material is positioned such that liquid flow through the waste outlet from the sample adequacy control chamber 624 flows over the pad 690.

The liquid handling device 600 therefore comprises two flow paths, each of which is in fluidic communication with the inlet conduit 614. A first flow path comprises the portion of the sample adequacy control chamber 624 that is downstream of the sample adequacy control chamber outlet port, the waste outlet from the sample adequacy control chamber 624, and the waste chamber 644. A second flow path comprises the sample adequacy control chamber outlet port and the outlet conduit 642. The junction between the flow paths is within the sample adequacy control chamber 624, meaning that the sample adequacy control chamber outlet port provides an inlet to the second flow path. As with the liquid handling device 400 described above, the second flow path of the liquid handling device 600 provides a higher hydraulic resistance than the first flow path.

In use (i.e. in the orientation shown in FIG. 14), the operation of the liquid handling device 600 is the same as the operation of the liquid handling device 500 described above, with the following exceptions.

Before the fill level of the sample adequacy control chamber 624 reaches the level of the waste outlet, the pad 690 of porous or absorbent material acts as an occluding material to occlude the contents of the sample adequacy control chamber 624. Once liquid fills the sample adequacy control chamber 624 to the level of the waste outlet, liquid flows through the waste outlet (i.e. openings 664, 684) and over the pad 690 of porous or absorbent material, which is visible through the viewing window 630. Once liquid had contacted the pad 690, the user is able to determine the presence of a volume of liquid within the sample adequacy control chamber 624. In particular, the user determines that a sufficient volume of liquid required for a particular diagnostic test has been received in the liquid handling device 600.

The liquid that flows through the waste outlet subsequently flows into the vented waste chamber 644.

The lack of constriction at the waste outlet from the sample adequacy control chamber 624 of the liquid handling device 600 means that there is a lower back pressure on the outlet conduit 642, compared to the back pressure on the outlet conduit 542 of the liquid handling device 500 and the outlet conduit 442 of the liquid handling device 400. In addition, by using the sample adequacy control chamber 624 to meter a specific volume of liquid, a lower volume of blood is required in order to indicate the presence or absence of a sufficient volume of liquid, when compared with the liquid handling device 400. Consequently, the liquid handling device 600 requires a reduced volume of sample in order to perform a diagnostic test, when compared with the liquid handling device 400.

The pad 690 of porous or absorbent material may be configured to provide a visual indication when contacted by a number of different types of liquid sample (e.g. serum, blood, plasma). This means that a cartridge comprising the liquid handling device 600 may be used for a wide variety of diagnostic tests involving different liquid sample types.

FIG. 15 shows a blood collection tube 11 being inserted into a cylinder of a liquid extraction device 200. In this example, the liquid extraction device 200 is integral with a cartridge 100 that comprises the functionality of the liquid handling device 400 described above. As described above with reference to FIGS. 1, 2A and 2B, the liquid extraction device comprises a liquid storage container interface (e.g. a needle) configured to provide a fluidic connection to the blood collection tube 11. The liquid storage container interface comprises a liquid extraction outlet configured to allow liquid to be extracted from the blood collection tube 11. The liquid extraction outlet is in fluidic communication with an inlet conduit in the cartridge (e.g. the inlet conduit 414 of the liquid handling device 400), such that liquid extracted from the blood collection tube 11 is received in the inlet conduit.

Again as described above with reference to FIGS. 1, 2A and 2B, the liquid extraction device 200 comprises a liquid extraction mechanism actuatable from a first configuration to a second configuration, wherein the liquid extraction mechanism is configured to provide a pressure difference between a volume of gas in the liquid storage container and the liquid extraction outlet, when the liquid extraction mechanism is actuated from the first configuration to the second configuration.

The blood collection tube 11 is shown as being inserted into the cylinder when the cartridge 100 is in a vertical orientation. FIG. 15 also shows an indicator region in the form of an optically clear viewing window 130 in a side wall of the cartridge 100. The sample adequacy control chamber (and/or a pad of porous or absorbent material) is viewable through the window 130. The window 130 may, for example, be provided in the form of the viewing window 430 of the liquid handling device 400.

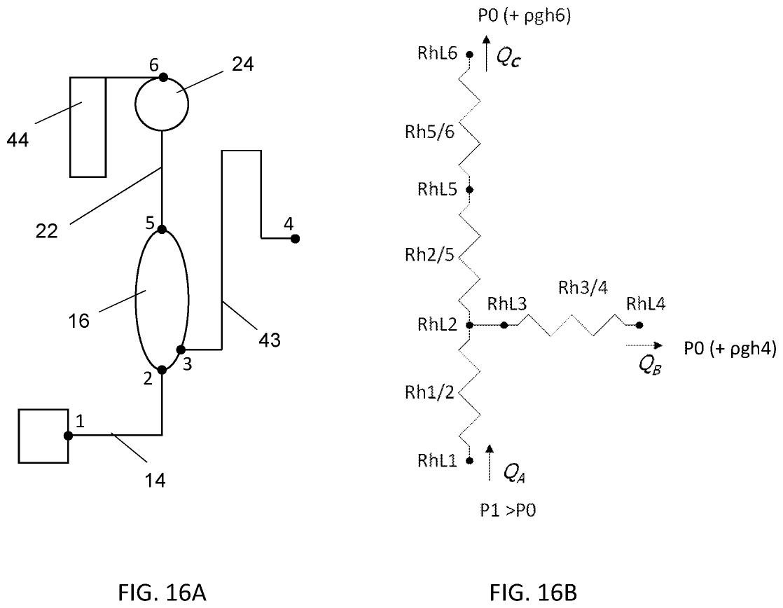

FIG. 16A is a schematic diagram of a fluidic configuration of a liquid handling device comprising a sample adequacy control chamber 24. The fluidic configuration is described with reference to the fluidic components shown in FIG. 1. In particular: the inlet to the inlet conduit 14 (e.g. the outlet from a liquid extraction device) is indicated as point (1); the metering chamber inlet port is indicated as point (2); the first metering chamber outlet port, providing the fluidic connection to the outlet conduit 43, is indicated as point (3); the end of the outlet conduit 43 is indicated as point (4); the second metering chamber outlet port, providing the fluidic connection to the connector conduit 22, is indicated as point (5); and the waste outlet from the sample adequacy control chamber 24, which provides a fluidic connection to the waste chamber 44, is indicated as point (6).

FIG. 16B is a schematic diagram of a circuit equivalent to the fluidic configuration shown in FIG. 16A. As shown in FIG. 16B, each of points (1) to (6) provides a respective local resistance, RhL1 to RhL6. In addition, a friction resistance Rh1/2 is provided between points (1) and (2) (i.e. the inlet conduit 14), a friction resistance Rh3/4 is provided between points (3) and (4) (i.e. the outlet conduit 43), a friction resistance Rh2/5 is provided between points (2) and (5) (i.e. the metering chamber 16), and a friction resistance Rh5/6 is provided between points (5) and (6) (i.e. the connector conduit 22 and sample adequacy control chamber 24).

The pressure at point (1) is P1, which is greater than atmospheric pressure (P0), meaning that pressurised fluid is provided to the liquid handling device. The pressure at point (6) is the sum of atmospheric pressure P0 and the gravitational pressure component resulting from the height of point (6) above point (1) (i.e. pgh6). The pressure at point (4) is the sum of atmospheric pressure P0 and the gravitational pressure component resulting from the height of point (4) above point (1) (i.e. pgh4).

As shown in FIGS. 16A and 16B, two flow paths are in fluidic communication with the inlet conduit 14. A first flow path is provided along points (2), (5) and (6). A second flow path is provided between points (3) and (4). The liquid flow rate through the inlet conduit 14 is denoted Q_{A}, while the liquid flow rate through the second flow path is denoted Q_{B} and the liquid flow rate through the first flow path is denoted Q_{C}. It will be appreciated that Q_{A}=Q_{B}+Q_{C}.

To prevent liquid from flowing into the cartridge through the second flow path (i.e. (3)-(4)), Q_{B} must be much less than Q_{C}, i.e. Q_{B}<<Q_{C}.

The resistance along a circular pipe, assuming turbulent flow, can be calculated using the Darcy-Weisbach empirical equation and a circular cross section:

$$Δ p = \frac{46 {f}_{D} L}{2 gD ( π {D}^{2} )} {Q}^{2} = {K}_{i} {Q}^{2} \qquad Equation 3$$

Where:
Δp is the pressure drop between two points within the pipe;
f_{D} is the Darcy friction factor, calculated from the Colebrook equation or approximations for it, such as the Churchill equation;
L is the length of pipe between the two points;

$$g = 9.81 m / {s}^{2} ;$$

D is the diameter of pipe;
Kᵢ is the hydraulic resistance coefficient for the pipe;
Q is the flow rate.

Equation 3 can be used to calculate the friction component of the hydraulic resistance provided by the conduits/channels shown in FIGS. 16A and 16B (i.e. Rh1/2, Rh3/4, Rh2/5 and Rh5/6). As seen from Equation 3, the hydraulic resistance is inversely proportional to the square of the flow rate.

The local resistance provided by an orifice or via (e.g. point (3)) can be derived using the theory of flow through an orifice plate, and Bernoulli's equation, which is an approximation of the flow through point (3):

$$Q = \frac{{C}_{d} π {d}^{2}}{4 \sqrt{1 - {( \frac{d}{D} )}^{4}}} \sqrt{\frac{2 ( {p}_{upstream} - {p}_{downstream} )}{ρ}} \qquad Equation 4$$

Where:
C_{d} is the coefficient of discharge, typically between 0.65 and 0.7 for a via or orifice;
d is the diameter of the via or orifice;
D is the diameter of the pipe (i.e. upstream of the via or orifice); Pᵤₚₛₜᵣₑₐₘ is the pressure upstream of the via or orifice;
P_{downstream} is the pressure downstream of the via or orifice;
ρ is the density of the liquid.

From Equation 4, it follows that:

$$Δ p = \frac{8 ρ ( 1 - {( \frac{d}{D} )}^{4} )}{{C}_{d}^{2} {π}^{2} {d}^{4}} {Q}^{2} = {K}_{3} {Q}^{2} \qquad Equation 5$$

Where:
Δp is the pressure drop between the points upstream and downstream of the via or orifice;
K₃ is the hydraulic resistance coefficient for the orifice or via (e.g. at point (3)).

As seen from Equation 5, the hydraulic resistance is again inversely proportional to the square of the flow rate.

The local resistance provided by the constriction at point (5) (i.e. the constriction provided by the connector conduit 22) can be derived using expansion and contraction flow theory. The local resistance depends on the angle of the constriction. The local resistance is given by:

$${Δ}_{p} = {K}_{5} {Q}^{2} \qquad Equation 6$$

Where:
Δp is the pressure difference between points upstream and downstream of the constriction;
K₅ is the hydraulic resistance coefficient for the constriction (e.g. at point (5));
Q is the flow rate.

The expression for K₅ depends on the angle of the constriction (i.e. the angle of the constriction between the wider, upstream pipe and the narrower, downstream pipe, where a stepped constriction would have θ=90°). Specifically, for θ≤45°:

$${K}_{5} = 0.8 \times sin ( \frac{θ}{2} ( 1 - {( \frac{d}{D} )}^{2} ) ) \qquad Equation 7$$

Where:
θ is the angle of the constriction;
d is the diameter of the pipe downstream of the constriction;
D is the diameter of the pipe upstream of the constriction.

For θ>45°:

$${K}_{5} = 0.5 \times \sqrt{sin ( \frac{θ}{2} ( 1 - {( \frac{d}{D} )}^{2} ) )} \qquad Equation 8$$

From Equation 6, it can be seen that the hydraulic resistance is again inversely proportional to the square of the flow rate.

The total hydraulic resistance of the first flow path (points (2)-(5)-(6)) is given by:

$${K}_{C} = \sum {R}_{h} [ F 1 ] = ( {K}_{25} + {K}_{5} + {K}_{56} ) \qquad Equation 9$$

The total hydraulic resistance of the second flow path (points (3)-(4)) is given by:

$${K}_{B} = \sum {R}_{h} [ F 2 ] = ( {K}_{3} + {K}_{34} ) \qquad Equation 10$$

From the above equations, it can be seen that the total hydraulic resistances of the first and second flow paths, when neglecting height variations between point (4) and point (6), are each inversely proportional to the square of the flow rate through the flow path:

$$Δ p = {K}_{i} \times {Q}_{i}^{2} \qquad Equation 11$$

Where Ki is the hydraulic resistance coefficient of the flow path.

This means that:

$${K}_{i} = Δ p / {Q}_{i}^{2} \qquad Equation 12$$

As explained above, the ends of the first and second flow paths are at atmospheric pressure. This means that, when neglecting height variations between point (4) and point (6), the pressure drop over the first flow path is the same as the pressure drop over the second flow path.

This means that:

$${K}_{C} \times {Q}_{C}^{2} = {K}_{B} \times {Q}_{B}^{2} ,$$

$$meaning$$

$${K}_{B} / {K}_{C} = {Q}_{C}^{2} / {Q}_{B}^{2} .$$

To provide the lower flow rate through the second flow path, the flow rate through the first flow path, Q_{C}, should be a factor N higher than the flow rate through the second flow path, Q_{B}, i.e.:

$${Q}_{C} = N \times {Q}_{B} \qquad Equation 13$$

To provide a flow rate Q_{C} that is N times higher than Q_{B}, the hydraulic resistance of the second flow path needs to be No greater than the hydraulic resistance of the first flow path, as shown from Equation 14:

$${K}_{B} = {K}_{C} \times ( {Q}_{C}^{2} / {Q}_{B}^{2} ) = {K}_{C} \times {N}^{2} \qquad Equation 14$$

As one specific example of tuning the hydraulic resistance of the second flow path, a target time for extracting liquid from a blood collection tube and providing the visual indication that a sufficient volume of liquid (around 300 μL or less) has been extracted is between 10 and 30 seconds. In this specific example, the expected flow rate through the first flow path, Q_{C}, is between 5 and 30 μL/s, and the preferred flow rate through the second flow path, Q_{B}, is between 0.1 and 1 μL/s, in order to ensure that the outlet conduit is never completely filled during extraction of liquid.

In this specific example, preferred values of Nare 5, 20 and 50.

From Equation 14, it can be seen that: to provide a value of N=5, the hydraulic resistance of the second flow path needs to be N²=25 times higher than the hydraulic resistance of the first flow path; to provide a value of N=20, the hydraulic resistance of the second flow path needs to be N²=400 times higher than the hydraulic resistance of the first flow path; and to provide a value of N=50, the hydraulic resistance of the second flow path needs to be N²=2500 times higher than the hydraulic resistance of the first flow path.

Further variations or modifications to the systems and methods described herein are set out in the following paragraphs.

The indicator region of the liquid handling devices described above may further comprise an occluding material in the wall of the device through which the sample adequacy control chamber is viewable. The occluding material may be provided in the form of roughness introduced in the moulded wall forming the top of the sample adequacy control chamber, where the roughness is configured to look hazy when dry, and clear when wetted. In this case, the occluding material is the same material as the material of the first or second moulded part. The occluding material may be configured to occlude at least a portion of the sample adequacy control chamber until the occluding material is in contact with a quantity of liquid.

For example, the liquid handling device 400 may comprise an occluding material that occludes the liquid within the metering chamber 416, until the liquid reaches a certain fill level within the sample adequacy control chamber 424. As another example, the liquid handling device 500 may comprise an occluding material instead of extending the second moulded part 540 to cover the top of the sample adequacy control chamber 524. In the liquid handling devices 500, 600, the occluding material may be provided over the pad 590, 690 of porous or absorbent material, or may be incorporated into the pad 590, 690, such that the pad 590, 690 is only viewable when the occluding material contacts a quantity of liquid. As a further example, the liquid handling device 600 may incorporate an occluding material instead of the pad 690 of porous or absorbent material, such that the interior of the sample adequacy control chamber 624 is visible once the occluding material is contacted by a quantity of liquid. The occluding material may be a material that becomes more optically clear when in contact with a volume of liquid (e.g. using an optical coupling effect).

Although the above implementations are described with reference to extracting liquid from a blood collection tube such as a Vacutainer (RTM), it will be appreciated that the implementations described above are also suitable for extracting liquid from other forms of pierceable liquid storage containers, which may differ in size and/or shape from blood collection tubes. In such cases, the dimensions of the cylinder may be adapted to the size and shape of the liquid storage container from which liquid is to be extracted.

Additionally, although the above implementations use a liquid storage container interface (e.g. a blood collection tube interface) in the form of one or more needles, other liquid storage container interfaces may be implemented, provided that they are capable of providing a fluidic connection to a volume of liquid within a liquid storage container (e.g. to a volume of liquid within the blood collection tube 11).

The term “needle” in the above implementations is not intended to be limited to metal needles, and is intended to cover other piercing elements that are configured to pierce a septum of a blood collection tube, such as piercing elements that are integral with a piston.

Finally, although the above implementations are described with reference to a force applied by a user to actuate the liquid extraction mechanism, it will be appreciated that the liquid extraction mechanism may alternatively be actuated without requiring user input (e.g. under control of a motor).

As a general point, although the above implementations are described with reference to extracting liquid for use in a diagnostic test carried out using a cartridge, it will be appreciated that the liquid handling devices described above are suitable for allowing the presence or absence of a volume of liquid within a sample adequacy control chamber to be determined for a wide range of other purposes.

The term “chamber” as used herein is not intended to convey specific shapes or dimensions of chamber. In addition, the use of the term “chamber” does not mean that there is a step change in cross-sectional area at the interface between a “conduit” and a “chamber”. In particular, the chambers described herein may be implemented using a continuous conduit with a wider cross-section in the regions of the chambers.

The term “conduit” as used herein is intended to mean any form of enclosed passage along which fluid flows, and may alternatively be referred to as a passage, channel, pipe or duct.

The term “port” as used herein is intended to mean an opening that provides a fluidic entry or exit point to a conduit, and may alternatively be referred to as an opening, via, orifice, hole, or aperture.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. A liquid handling device, comprising:
an inlet conduit configured to receive a liquid sample;
a first flow path comprising a sample adequacy control chamber in fluidic communication with the inlet conduit, wherein the sample adequacy control chamber is configured to allow the presence or absence of a volume of liquid within the sample adequacy control chamber to be determined; and
a second flow path in fluidic communication with the inlet conduit, wherein the second flow path is configured to provide a higher hydraulic resistance than the first flow path.

2. A liquid handling device according to claim 1, wherein the liquid handling device comprises an indicator region through which the sample adequacy control chamber is viewable, such that a user can determine the presence or absence of the volume of liquid within the sample adequacy control chamber.

3. A liquid handling device according to claim 2, wherein the indicator region through which the sample adequacy control chamber is viewable is downstream from a sample adequacy control chamber inlet port in the first flow path.

4. A liquid handling device according to any of claims 1 to 3, wherein the second flow path comprises an outlet conduit, wherein the outlet conduit has a smaller cross-sectional area than the inlet conduit.

5. A liquid handling device according to any of claims 2 to 4 when dependent on claim 2, wherein the sample adequacy control chamber comprises:
a sample adequacy control chamber inlet port configured to receive liquid from the inlet conduit; and
a sample adequacy control chamber outlet port in fluidic connection with the second flow path;
wherein the distance between the sample adequacy control chamber outlet port and the indicator region is less than the distance between the sample adequacy control chamber inlet port and the indicator region.

6. A liquid handling device according to any of claims 1 to 4, wherein the first flow path further comprises a metering chamber configured to store a specific volume of liquid, wherein the metering chamber comprises:
a metering chamber inlet port configured to receive liquid from the inlet conduit; and
a metering chamber outlet port in fluidic connection with the second flow path.

7. A liquid handling device according to claim 6, wherein the first flow path comprises a connector conduit providing a fluidic connection between the metering chamber and the sample adequacy control chamber.

8. A liquid handling device according to claim 7, wherein the cross-sectional area of the connector conduit is smaller than the cross-sectional area of the metering chamber.

9. A liquid handling device according to claim 7 or claim 8, wherein the second flow path comprises an outlet conduit, wherein the cross-sectional area of the connector conduit is greater than or equal to the cross-sectional area of the outlet conduit.

10. A liquid handling device according to any of claims 6 to 9, wherein the sample adequacy control chamber is downstream from the metering chamber.

11. A liquid handling device according to any of claims 6 to 10 when dependent on claim 2, wherein the distance between the metering chamber outlet port and the indicator region is less than the distance between the metering chamber inlet port and the indicator region.

12. A liquid handling device according to any of claims 2 to 11 when dependent on claim 2, wherein the second flow path comprises an outlet conduit section extending in the direction of the indicator region.

13. A liquid handling device according to any of claims 1 to 12, wherein the first flow path comprises a vented waste chamber in fluidic communication with the sample adequacy control chamber.

14. A liquid handling device according to claim 13, wherein the sample adequacy control chamber comprises a waste outlet providing a fluidic connection to the waste chamber, wherein the waste outlet is located between an upper end and a lower end of the sample adequacy control chamber, wherein the distance between the upper end of the sample adequacy control chamber and the indicator region is less than the distance between the lower end of the sample adequacy control chamber and the indicator region.

15. A liquid handling device according to any of claims 1 to 14, further comprising a pad of porous material, wherein the pad is configured to contact liquid within the sample adequacy control chamber.

16. A liquid handling device according to any of claims 1 to 14, further comprising a pad of absorbent material, wherein the pad is configured to absorb liquid within the sample adequacy control chamber.

17. A liquid handling device according to any of claims 1 to 16, further comprising an occluding material provided in a wall of the liquid handling device through which the sample adequacy control chamber is viewable, wherein the occluding material is configured to occlude at least a portion of the sample adequacy control chamber until the occluding material is in contact with a quantity of liquid.

18. A liquid handling device according to any of claims 1 to 17, further comprising:
a liquid storage container interface configured to provide a fluidic connection to a volume of liquid within a pierceable liquid storage container, the liquid storage container interface comprising a liquid extraction outlet configured to allow liquid to be extracted from the liquid storage container;
wherein the liquid extraction outlet is in fluidic communication with the inlet conduit such that liquid extracted from the liquid storage container is received in the inlet conduit.

19. A liquid handling device according to claim 18, further comprising a liquid extraction mechanism actuatable from a first configuration to a second configuration, wherein the liquid extraction mechanism is configured to provide a pressure difference between a volume of gas in the liquid storage container and the liquid extraction outlet, when the liquid extraction mechanism is actuated from the first configuration to the second configuration.
